(19) United States
(12) Patent Application Publication
(10) Pub. No.: US 2002/0175119 A1
(43) Pub. Date: Nov. 28, 2002

(54) Device for fractionating mixtures

(76) Inventor: Michel Perrut, Nancy (FR)

Correspondence Address: ALLEN BLOOM, C/O DECHERT, PRINCETON PIKE CORPORATION CENTER, P.O. BOX 5218, PRINCETON, NJ, 08543-5218, US

(21) Appl. No.: 09/980,345

(22) PCT Filed: May 31, 2000
(86) PCT No.: PCT/FR00/01503

(30) Foreign Application Priority Data
Jun. 4, 1999 (FR) 99 07088

(51) Int. Cl. B01D 63/02

(52) U.S. Cl. 210/321.8; 210/416.1

(57) ABSTRACT

The invention relates to a device for fractionating mixtures comprising separation elements which are series mounted and mounted in a closed loop. Said device is characterized in that the solvent used is a supercritical pressurized fluid, each of the separation elements is made of a membrane separation, it comprises means for injecting the solvent at a pressure which is greater than the critical pressure thereof and for maintaining the pressure in said loop at a value which is above critical pressure, and it further comprises means for injecting the diluent and for maintaining the pressure thereof at a value which is similar to the value of the pressure of the solvent (S) in each of the areas (I, II, III, IV).

The present invention relates to an industrial device for fractionating mixtures of components with the aid of solvents. It concerns more precisely the use to that end of a liquid solvent, called diluent, and of a solvent taken to supercritical pressure, i.e. a fluid in supercritical state or a subcritical liquid, and this by using porous membranes.

Bodies are generally known to be in three states: solid, liquid and gaseous, and one passes from one of these states to another state by varying the temperature and/or the pressure. Now, there is a point beyond which one can pass from the liquid state to the vapour state without passing through boiling or, inversely, by condensation, such passage in that case being effected continuously. Such a point is called the critical point.

“Supercritical fluid” will designate a fluid which is in a state characterized either by a pressure and a temperature respectively higher than the critical pressure and temperature in the case of a pure body, or by a representative point (on a pressure/temperature graph) located beyond the envelope of the critical points in the case of a mixture. Such a supercritical fluid presents, for very numerous substances, a high solvent power, much greater than that of this same fluid in the state of compressed gas.

The same applies to so-called “subcritical” liquids, i.e. which are in a state characterized either by a pressure higher than the critical pressure and by a temperature lower than the critical temperature, in the case of a pure body, or by a pressure higher than the critical pressures of the components and a temperature lower than the critical temperatures of the components in the case of a mixture.

The considerable and modulatable variations of the solvent power of these fluids are, moreover, used in numerous methods of extraction (solid/fluid), of fractionation (liquid/fluid), of analytic or preparative chromatography, of treatment of materials (ceramics, polymers). Chemical or biochemical reactions are also made in such solvents.

It will be noted that the physico-chemical properties of carbon dioxide as well as its critical pressure of 7.4 MPa and its critical temperature of 31° C., make a preferred solvent of it in numerous applications, all the more so as it does not present any toxicity and is available in very large quantities at very low cost. Moreover, as a non-polar solvent, carbon dioxide taken to supercritical pressure sometimes has a co-solvent added thereto, constituted by a polar organic solvent which will considerably modify its solvent power, especially with respect to molecules presenting a certain polarity. Ethanol is sometimes used to that end.

One of the principal advantages of the methods employing fluids at supercritical pressure resides in the facility of effecting separation between the solvent (the fluid) and the extracts and solutes, as has been described in numerous publications and, for certain important aspects of implementation, in Patent FR-A-2 584 618. The interesting properties of these fluids have, moreover, been used for a long time in solid-fluid extraction and liquid-fluid fractionation.

The present invention has for its object to allow, for industrial production purposes, the separation of a liquid mixture into its different fractions by using a system derived in its general conception from the methods conventionally called “fluid-liquid or liquid-liquid countercurrent fractionation” such as those used on a large scale for several decades.

According to the invention, different elementary separation modules will be combined, each being constituted by a generally cylindrical recipient containing a porous membrane ensuring separation between two fluid phases, between which solutes will be exchanged through this porous membrane. These modules will preferably be constituted by a bundle of hollow, permeable fibers which will be disposed along the longitudinal axis of the cylindrical recipient in order to ensure a large surface of membrane per unit of volume of the recipient, one of the fluids circulating inside the fibers and the other fluid circulating outside.

The first finction of the porous membrane is to separate the two phases between which the transfer of solute will be effected, namely a liquid phase and a fluid phase at supercritical pressure. Such phase separation is possible due to the forces of capillarity which maintain the interface at the level of the orifices of very small diameter of the porous membrane. Such membranes are currently used in industry for separating liquid fluids or a liquid fluid and a gaseous fluid. In the case of the present invention, the porous membrane must, of course, be made of a material which is not altered by the two fluids and, particularly by the fluid at supercritical pressure which is known to have the property of modifying the morphology of organic polymers. Inorganic membranes will therefore preferably be chosen, such as those conventionally used in ultrafiltration, or organic membranes not affected by the fluids at supercritical pressure, such as under the Trademark POROCRIT and which are formed by a bundle of hollow permeable fibers of polypropylene.

For convenience, the following appellations will be used:

diluent: the liquid fluid,

solvent: the fluid at supercritical pressure,

solutes: the compounds to be fractionated.

The present invention thus has for its object a device for fractionating mixtures into their various components, of the type comprising separation elements mounted in series and in a closed loop, presenting alternating points of injection and points of drawing-off along the series of the separation elements, in which the closed loop is formed by successive areas each constituted by at least one separation element, this device comprising at least one point of injection of solvent and one point of injection of diluent located between two respective areas, a point of injection of mixture, at least one point of drawing-off of extract located downstream of the point of injection of mixture, in the direction of circulation of the solvent, and a point of drawing-off of raffinate located upstream of the point of injection of mixture, in the direction of circulation of the solvent, characterized in that:

the solvent is a supercritical pressurized fluid,

each of the separation elements is constituted by a membrane phase separation element,

it comprises means for injecting the solvent at a pressure greater than its critical pressure, and for maintaining the pressure in said loop at a value above critical pressure,

it comprises means for injecting the diluent and for maintaining the pressure thereof at a value similar to that of the solvent in each of the areas.

In an embodiment of the invention, the membrane separation elements are constituted by a cylindrical envelope containing a bundle of hollow, permeable fibers disposed along the longitudinal axis of the envelope and means for inlet and outlet of the fluids so that one of the fluids circulates inside the fibers and the other outside them. The fibers may preferably be constituted by polypropylene.

Furthermore, the respective pressures in each of the areas may be such that the solvent power of the solvent S in each area will be maintained constant and will be different from one area to the other. This solvent power will preferably decrease in the direction S of flow of the solvent.

The device according to the invention may comprise a pumping system intended to increase the pressure of the diluent between each area in the direction of flow thereof and a system for balancing the pressures of the diluent and of the solvent in each of these areas.

To that end, volumetric pumps will preferably be used in order to circulate the diluent at controlled flowrates in each of the respective areas.

The pressure balancing system may be constituted by respective balancing recipients associated with each area, which will be connected to each of the streams of diluent and of solvent respectively entering and leaving each downstream area in the direction of circulation of the solvent. The interface between the diluent and the solvent may be maintained stable by means of a system for measuring the respective levels acting on the regulation of flowrate of the corresponding pump.

Various forms of embodiment of the present invention will be described hereinafter by way of non-limiting examples, with reference to the accompanying drawings, in which:

FIG. 1 is a diagram of the mixture fractionating device according to the invention, comprising four areas of functioning.

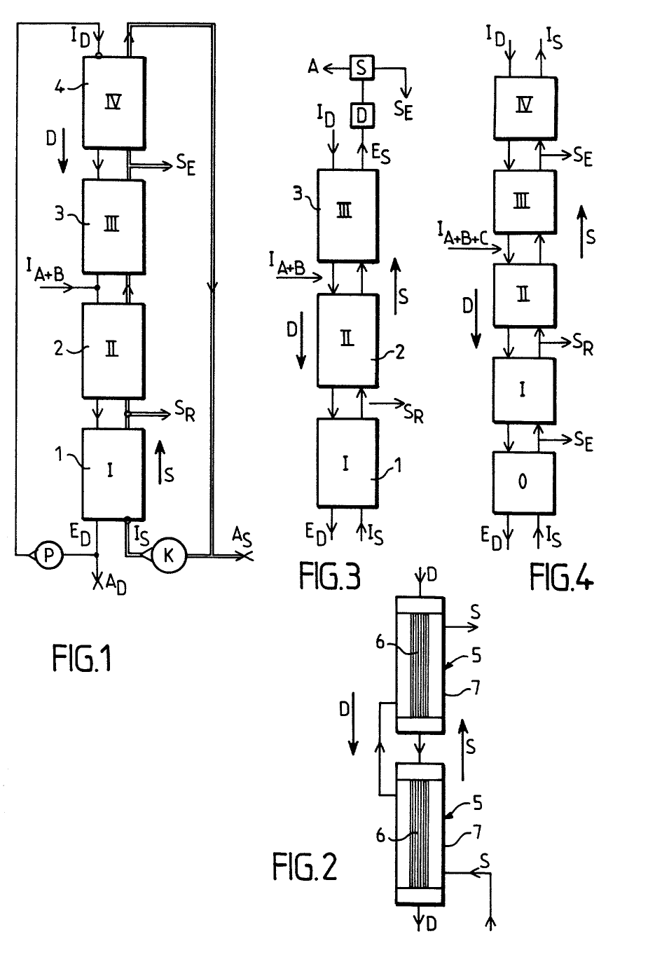

FIG. 2 schematically shows the arrangement in series of two membrane separation elements and the respective paths therethrough of the diluent and of the solvent.

FIG. 3 schematically shows a variant fractionating device according to the invention comprising three areas of functioning.

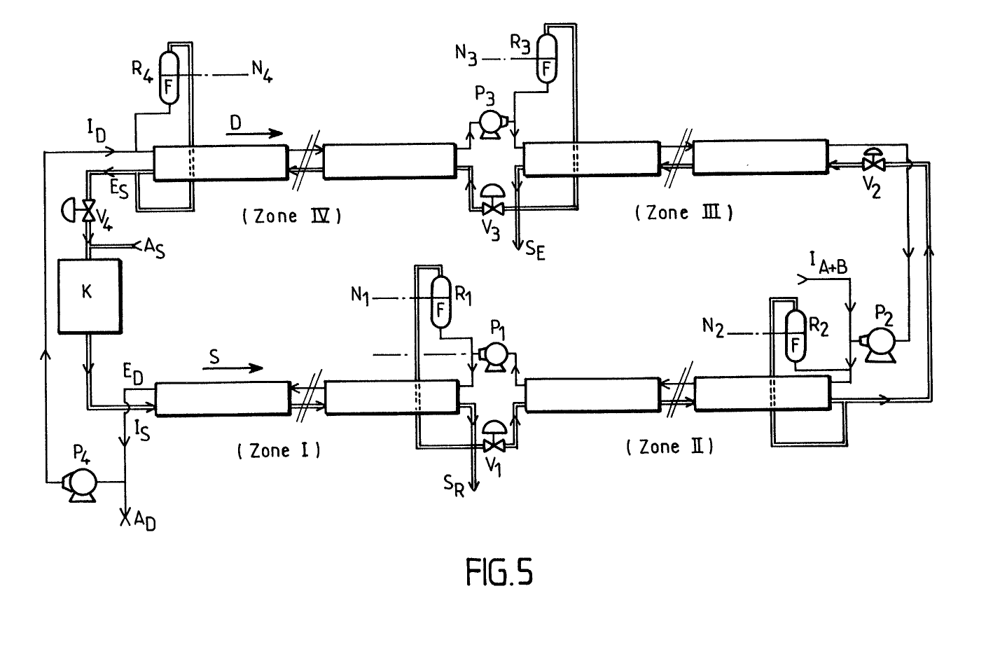

FIG. 4 schematically shows another variant of a fractionating device comprising five areas of functioning allowing mixtures to be fractionated into three fractions.

FIG. 5 is a schematic view of a form of embodiment of the invention and in particular of means for balancing the pressures in the areas of the loop.

In the following specification and for simplification, we shall limit ourselves to the case of a mixture of two components A and B to be separated into two cuts, which gives a circuit comprising, in series, a point of injection Iₛ of solvent and a point of injection ID of diluent, a point of drawing-off S_{E} of extract, a point of injection I_{A+B} of the mixture to be fractionated and a point of drawing-off S_{R} of raffinate, a point of drawing-off or of addition of diluent A_{D} and a point of drawing-off or of addition of solvent A_{S}, as shown in FIG. 1.

According to the invention, each of the separation modules may be constituted by a separation element 5 or by a plurality thereof which will, in that case, be disposed in series.

In FIG. 1, the fractionating device comprises four separation modules 1, 2, 3 and 4 successively defining four respective areas I to IV.

Each of the separation elements 5 is constituted by porous membranes. These porous membranes, which must be stable in the presence of the diluent, the solvent at supercritical pressure and the solutes, are constituted by inorganic membranes, such as those derived from the diffusion barriers used for isotopic separation or those used in ultrafiltration, as well as certain membranes constructed of organic polymer. Use will preferably be made of membranes constituted by bundles of hollow porous fibers 6 of polypropylene which appear well adapted to the use of the solvent at supercritical pressure, particularly when it is constituted by carbon dioxide, and to the use of numerous solutes dissolved in an aqueous phase or in an organic phase. Hollow-fiber separator modules marketed under the Trademark POROCRIT will, for example, be mentioned. In the separation elements 5, the diluent D circulates inside the fibers 6 and the solvent S circulates outside them on the recipient side, as schematically represented in FIG. 2.

The solvent S used is constituted by a fluid at supercritical pressure, preferably carbon dioxide. It is introduced at Is in module 1, by a compressor or a pump K, in the direction of circulation of the solvent S represented in the Figure by arrow S.

The diluent D is generally constituted by a liquid which is insoluble or very sparingly soluble in the solvent S. In the embodiments described hereinafter, it is constituted by an aqueous phase and is introduced at I_{D} by a pump P which causes it to circulate in the direction opposite the solvent, in the direction of arrow D.

The mixture containing the components A and B which it is desired to separate is dissolved in the diluent phase and is introduced at I_{A+B} between the areas II and III.

The components A and B are drawn off in the form of raffinate essentially containing the compound B at SR between the area I and area II and in the form of extract essentially containing component A at S_{E} between the area III and the area IV, it being specified that this raffinate and this extract are drawn off in a form dissolved in the stream of solvent S.

The solvent S circulating in countercurrent with respect to the diluent D and the mixture A+B being injected between the area II and the area III, the components A and B will be distributed between the diluent and the solvent. The components with greater affinity with the solvent will therefore be entrained with greater difficulty by the diluent and will preferentially follow the solvent, while the components with less affinity with the solvent will tend to be more easily entrained by the diluent.

It may therefore be considered, on schematizing, that from each area to the following, the solvent power of the solvent S must decrease, if not remain equal, and cannot increase except, of course, when one is located at the outlet of area IV (in order to be recycled in area I) concerning the solvent and at the outlet of area I (to be recycled in area IV) concerning the diluent D.

According to the invention, in order to obtain correct separation between the two phases while ensuring transfer of the solutes therebetween, the two fluids, on either side of the membrane, will be arranged to be maintained at pressures very close to each other, so that the capillary forces prevent one of the phases from percolating through the membrane to be mixed with the other phase. The liquid phase will therefore be arranged to be maintained at a pressure close to that of the fluid at supercritical pressure, and this at any moment of the method, including during the transitory operational phases.

The device according to the invention comprises conventional means for circulating the liquid diluent and for circulating the solvent at supercritical pressure, such as those used in extraction-fractionation installations using the fluids at supercritical pressure. In this way, the circulation of the diluent is ensured by pumps P and that of the solvent at supercritical pressure may be ensured either by a compressor K, or by a pump conveying the fluid in the liquefied state which is then reheated to the required temperature.

In the case which has just been described, we have limited ourselves to the case of two constituents A and B but, as has been emphasized previously, this case may be extended to more than two constituents by increasing the number of the points of drawing-off downstream or upstream with respect to the point of injection I_{A+B} of the mixture A+B.

It is, of course, possible to inject the mixture to be separated either in the diluent liquid phase or in the solvent phase at supercritical pressure and to draw off the fractions A and B either in solution in the diluent or in the solvent.

However, it is simply more practical to inject a liquid solution of the mixture in the diluent than a supercritical solution.

Furthermore, although the drawing off of the fractions may be effected in the diluent phase rather than in the solvent phase, it is, however, more convenient and less expensive, in general, to separate the solvent and the fractions rich in products A and B to be respectively extracted, taking into account the specific properties of the fluids in supercritical state as has been mentioned below, rather than to separate the fractions rich in products A and B respectively and the diluent D by using methods such as distillation and crystallization.

In a particular embodiment of the invention, the separation will preferably be carried out so that the solvent power of the solvent S is maintained constant in each of the areas, but is different from one area to another, fundamentally unlike what is effected in the conventional countercurrent extraction methods.

Such an implementation is rendered possible by the particular properties of the above-mentioned fluids at supercritical pressure, provided that suitable equipment is designed for carrying out such a variation. According to the invention, the power of elution will be modulated by varying the pressure of the solvent S, which is relatively easy in certain pressure/temperature ranges.

In fact, for technological reasons, it is not simple to effect such a modulation of the solvent power by a variation of pressure at constant temperaure (isothermic regime). Without this constituting a limitation to the implementation of the method forming the subject matter of the present invention, it will therefore be preferred to effect said modulation by a variation of pressure with constant enthalpy (adiabatic or isenthalpic regime). This will lead to choosing the operational parameters of the installation in an area of the pressure-temperature diagram of the eluent fluid within which the variations of temperature will remain very small (some degrees Kelvin) during the operations of modulation of the pressure between the areas.

It has been ascertained experimentally that the solvent powers of the fluid S, in each of the four areas defined in FIGS. 1, 3 and 4, must be decreasing, which implies that the pressures prevailing in each of these areas must be decreasing, without it being excluded that they may be equal in two or three successive areas, and even the four areas (isobaric regine). It will be noted that, contrary to the solvent S which circulates from upstream to downstream in areas taken to decreasing pressures, the diluent D circulates in countercurrent in successive areas taken to increasing pressures very close to those of the solvent in each of them.

The device according to the invention allows an economically advantageous implementation from the industrial standpoint. A possible embodiment is illustrated in FIG. 5. In the latter, the flow of the solvent S at supercritical pressure between its point of inlet I_{S} and its point of outlet E_{S} is effected without noteworthy loss of pressure through the separation modules except for the noted valves (Vₖ with k=1,2,3,4 representing the number of the area concerned) located downstream in the direction S of circulation of the solvent of areas I, II, III and IV, in which the desired pressure loss will be effected in order to regulate the pressures in these areas perfectly to the values chosen by the operator.

The flow of the diluent D between its point of inlet I^{D} and its point of outlet E_{D} is effected without noteworthy loss of pressure through the separation modules, but requires a pumping system to increase the pressure of the diluent between each of the areas and a system for balancing the pressures of the diluent D and of the solvent S in each of these areas. To that end, volumetric piston or diaphragm pumps (Pₖ) are used for circulating the diluent D at well controlled flowrates in each of the areas I to IV and there is arranged a system for balancing the pressures between the diluent D and the solvent S constituted for example by a cylindrical recipient (Rₖ) connected to each of the streams of diluent D and of solvent S respectively entering and leaving the downstream area (K) in the direction of circulation of the solvent, in which the interface (F) between the diluent and the solvent is maintained stable thanks to a level measuring system (Nₖ) acting on the regulation of the flowrate of the diluent pump (Pₖ) located upstream of said area. This simple system is easily automatizable and the necessary pumps and valves are available and have been tested on a large scale in installations employing supercritical fluids.

The supply of the mixture to be separated introduced at point I_{A+B} may be effected either directly without prior dilution, if the mixture is liquid at the supply temperature and pressure, or more generally and more favourably after dilution of said mixture in the diluent taken prior or subsequent to this dilution under conditions similar to those desired by the operator at the inlet of area II.

However, in a variant of the method, it is also possible to introduce the mixture to be separated dissolved in the solvent fluid S. This operation of dilution is conventionally effected in accordance with the usual rules of the art. By way of example, this operation may thus be favourably effected by dissolution of the solid mixture to be fractionated within the solvent percolating on a bed of said solid, which solvent in that case being found under conditions where its solvent power is fixed so that it attains the desired concentration in said mixture by saturation.

Similarly, if said mixture is liquid, the solvent may favourably be percolated to the state of bubbles within it, under conditions where it is saturated in said mixture on attaining the desired composition. If the mixture to be fractionated is gaseous or liquid, dissolution in the liquid eluent may likewise favourably be effected by an on-line mixture, the two fluxes being carefully regulated. This supply of the mixture to be separated is favourably effected at a temperature and pressure very similar to those fixed at the inlet of area II. In this way, the disturbances of the flow regime in the upstream and downstream separation modules are minimized. Moreover, in an interesting variant of the invention, this supply may be used as addition of enthalpy to the system. In effect, the most favourable implementation of the method consists, as described hereinabove, in effecting the isenthalpic pressure variations through regulation valves. In certain cases, said expansion may be accompanied by a noteworthy drop in temperature of the fluid which it is possible to compensate by introducing the mixture to be fractionated at a temperature higher than the temperature of the fluid.

When the circulation of the solvent S is ensured by a compressor K, the compression of the fluid is always a source of heating thereof and it is then possible to counterbalance this heating by introducing the addition of solvent at a temperature lower than that of the fluid issuing from the last upstream column. When the circulation of the solvent is ensured by a pump, the temperature of the solvent entering at Iₛ in the separation module 1 of area I is regulated thanks to a heat exchanger located downstream of said pump.

The raffinate and the extract which are drawn off are solutions of the fractionated mixture within a certain quantity of diluent or, more favourably, of the supercritical fluid constituting the solvent. The implementation of the prior art as described for example in afore-mentioned French Patent FR-A-2 584 618 makes it possible to separate the solvent from the products obtained, the solvent being able to be favourably recycled in the method via the addition of solvent AS.

One of the important advantages allowed by the method forming the subject matter of the invention precisely resides in the easy implementation of this operation, where, unlike the problems encountered when the raffmate and the extract are drawn off from the diluent, the separation does not require, in the present case, complex devices nor high energy consumption. Moreover, when the supercritical solvent is for example pure carbon dioxide, the fractionated products are not polluted by any trace of residual solvent, which constitutes a considerable additional advantage.

An example of application of the present invention will be described hereinafter, in which it is proposed to effect separation of the aromas of fermented or distilled drinks. It is known that such drinks are essentially constituted by water and ethanol and by components present in a very low quantity, namely the aromas, which give the taste and colour to these drinks. For example, concentrated rum is constituted by about 50% by mass of water, 50% by mass of ethanol and by less than 0.2% of aromas of which the most important are ethyl acetate and 2-pentanol. A selective separation of the aromas is very delicate as it is impossible to obtain them by distillation, the ethanol also being very volatile. In the examples, one has modelized the distilled drink by an aqueous solution of ethanol and ethyl acetate.

The fractionating device used is in accordance with that described with reference to FIG. 1. The equipment comprises 20 elementary modules which are connected in series so as to constitute the four separation modules 1, 2, 3 and 4, as shown in FIG. 1. Each elementary module is more precisely constituted by a bundle of 120 hollow fibers made of polypropylene, 40.3 cm long, with an outer diameter of 0.6 mm and a thickness of 0.3 mm, which is contained in a metal tube 7. The whole is subjected to a temperature carefully regulated at 40° C.

The flowrate of fluid being able to vary between 0.6 kg/hr. and 3 kg/hr. The liquid to be treated circulates inside the hollow fibers of the separator modules at a flowrate which may be varied between 0.1 kg/hr. and 0.5 kg/hr. thanks to volumetric piston pumps connected upstream of each of the areas.

### EXAMPLE 1

In the present example, the separation module 1 comprises nine elementary modules within which the pressures of the two phases are close to 20 MPa, the separation module 2 comprises five elementary modules within which the pressures of the two phases are close to 11 MPa, the separation module 3 comprises five elementary modules within which the pressures of the two phases are close to 10 MPa, and the separation module 4 comprises one elementary module within which the pressures of the two phases are close to 7.5 MPa. The flowrate of diluent D, water in the present case, introduced at I_{D} in area IV is fixed at 200 g/hr., that of solvent S, carbon dioxide, introduced at I_{S} in area I is 3000 g/hr., and that of the feedstock to be treated introduced in the diluent at I_{A+B} between the area III and the area II is fixed at 78 g/hr. and is constituted by 60 g/hr. of water, 13 g/hr. of ethanol and 5 g/hr. of ethyl acetate. The drawing-off flowrates of the solvent fluid at S_{E} between the area IV and the area III (called extract) is fixed at 500 g/hr. and that of drawing off of solvent fluid at S_{R} between area II and area I (called raffinate) is fixed at 1500 g/hr. When these conditions have been maintained constant for about an hour, the streams leaving the system are weighed and analyzed and one deduces therefrom the following flowrates expressed in grams per hour of the components in each of the fluid phases leaving the device, after elimination of the carbon dioxide:

EXAMPLE 1

| Stream | Ethanol (g.hr.) | Ethyl acetate (g/hr.) |
|---|---|---|
| DILUENT ex-area I (A_{D}) | 1 | traces |
| RAFFINATE (S_{R}) | 12.5 | traces |
| EXTRACT (S_{E}) | 0.5 | 4.9 |

The excellent selectivity of the method is ascertained and the quantities of ethanol and of ethyl acetate injected at I_{A+B} are indeed found again in the extract and the raffiate.

### EXAMPLE 2

In this example, the conditions are very similar to those used in Example 1, except that the separation modules are three in number and this time they are connected in accordance with the diagram presented in FIG. 3, the separation module 1 comprising ten elementary modules within which the pressures of the two phases are close to 20 MPa, the separation module 2 comprising five elementary modules within which the pressures of the two phases are close to 11 MPa and the separation module 3 comprising five elementary modules within which the pressures of the two phases are close to 10 MPa. The flowrate of water (diluent) introduced at I_{d} in area III is fixed at 200 g/hr., that of carbon dioxide (solvent) introduced at I_{S} in area I is 3000 g/hr., that of the feedstock to be treated introdued in the diluent at I_{A+B}, between the area III and the area II is 78 g/hr. This feedstock is constituted by 60 g/hr. of water, 13 g/hr. of ethanol and 5 g/hr. of ethyl acetate. The solvent fluid is entirely drawn off downstream of the area III at S_{E} and, after separation of the carbon dioxide, a liquid mixture called extract is obtained. Similarly, the drawing-off flowrate of solvent fluid at S_{R} between the area II and the area I (called raffinate) is fixed at 1500 g/hr. When these conditions have been maintained constant for about an hour, the streams leaving the system are weighed and analyzed. One deduces therefrom the following flowrates expressed in g per hour of the components in each of the fluid phases leaving the device, after elimination of the carbon dioxide:

EXAMPLE 2

| Stream | Ethanol (g/hr.) | Ethyl acetate (g/hr.) |
|---|---|---|
| DILUENT ex-area I (A_{D}) | 1 | traces |
| RAFFINATE (S_{R}) | 12.6 | traces |
| EXTRACT (S_{E}) | 0.4 | 4.9 |

It is ascertained that the results are very similar to those obtained in Example 1, although the method carried out is simplified with respect to the one used in that preceding Example.

### EXAMPLE 3

Another illustration of the method and of the equipment forming the subject matter of the invention may be implemented by using as solvent carbon dioxide to which is added a co-solvent constituted by a chiral compound, i.e. a pure optical isomer of the species in question which will be called resolution agent.

Thanks to this mixture which is taken to a supercritical pressure, a mixture constituted by a racemic, i.e. an equimolar mixture of the two enantiomers of the species in question which will be called the solute, will be separated. In effect, it is known that the interactions between the fluid at supercritical pressure and the two enantiomers constituting the solute are stereospecific and therefore make it possible to dissolve selectively in the solvent fluid one or the other of the enantiomers of the solute in accordance with the conformation of the resolution agent and the chiral recognition resulting therefrom. The selectivity is all the greater as the affmity of the molecules having to interact is great. In this way, it is known that a chiral base can be used as resolution agent to separate the enantiomers of organic acids. However, this separation has only been conducted with one stage of contact in “batch” mode, leading to a limited selectivity.

According to the method forming the subject matter of the invention, a racemic solute dissolved in the diluent may be fractionated by using a solvent constituted by a mixture comprising at least one resolution agent taken to a supercritical pressure. The resolution agent will be chosen so that it is not soluble in the diluent in order that it is not transferred in the diluent phase.

In a variant of this method, the same separation may be effected by using a resolution agent soluble in the diluent and non-soluble in the solvent at supercritical pressure. It should be noted that the chiral recognition is based on the formation of a complex between the resolution agent and one of the enantiomers of the solute, which complex must be labile enough to be easily broken after leaving the equipment in the form of extract or raffinate depending on the case, in order to allow the recovery of this enantiomer and the recycling of this resolution agent.

Taking up one of the examples cited, the method according to the invention carried out on the equipment described previously in Example 1, the twenty separation modules being connected so as to constitute four areas I to IV respectively constituted by two, eight, eight and two elementary modules, makes it possible continuously to obtain a resolution of the racemic solute constituted by ibuprofen by using a solvent constituted by carbon dioxide to which is added a resolution agent constituted by R-(+)-1-phenylethylamine. One has thus been able to obtain two fractions enriched with each of the enantiomers each presenting an enantiomeric excess equal to 35% with a productivity of 2 g/hr.

1. Device for fractionating mixtures into their various components (A, B), of the type comprising separation elements (5) mounted in series and in a closed loop, presenting alternating points of injection (I_{S}, I_{D}, I_{A+B}) and points of drawing-off (S_{E}, S_{R}) along the series of the separation elements, in which the closed loop is formed by successive areas (I, II, III, IV) each constituted by at least one separation element (5), this device comprising at least one point of injection (Iₛ) of solvent (S) and one point of injection (I_{D}) of diluent (D) located between two respective areas, a point of injection (I_{A+B}) of mixture, at least one point of drawing-off (S_{E}) of extract (E) located downstream of the point of injection (I_{A+B}) of mixture, in the direction of circulation of the solvent (S), and a point of drawing-off (S_{R}) of raffinate located upstream of the point of injection of mixture, in the direction of circulation of the solvent (S), characterized in that:
the solvent (S) is a supercritical pressurized fluid,
each of the separation elements is constituted by a membrane phase separation element (5),
it comprises means for injecting the solvent (S) at a pressure greater than its critical pressure, and for maintaining the pressure in said loop at a value above critical pressure,
it comprises means for injecting the diluent (D) and for maintaining the pressure thereof at a value similar to that of the solvent (S) in each of the areas (I, II, III, IV).

2. Device according to claim 1, characterized in that the separation elements are constituted by a cylindrical envelope containing a bundle of hollow, permeable fibers (6), disposed along the longitudinal axis of the envelope and fluid inlet and outlet means, so that one of the fluids circulates inside the fibers (6) and the other outside them.

3. Device according to claim 2, characterized in that the fibers (6) are constituted by polypropylene.

4. Device according to any one of the preceding claims, characterized in that the respective pressures in each of the areas (I, II, III, IV) are such that the solvent power of the solvent (S) in each area is maintained constant and is different from one area to another.

5. Device according to claim 4, characterized in that the solvent power of the solvent (S) decreases in the direction of its flow.

6. Device according to one of claims 4 or 5, characterized in that the enthalpy is maintained constant in all the areas (I, II, III, IV).

7. Device according to one of claims 4 to 6, characterized in that it comprises a pumping system in order to increase the pressure of the diluent (D) between each area (I, II, III, IV), in the direction of flow thereof, and a system for balancing the pressures of the diluent (D) and of the solvent (S) in each of these areas.

8. Device according to claim 7, characterized in that volumetric pumps (P1, P2, P3, P4) are used for circulating the diluent (D) at controlled flowrates in each of the respective areas (I, 11 111, IV).

9. Device according to one of claims 7 or 8, characterized in that the pressure balancing system is constituted by balancing recipients (R1, R2, R3, R4) respectively associated with each area (I, II, III, IV) and which are connected to each of the streams of diluent (D) and of solvent (S) respectively entering and leaving each downstream area, in the direction of circulation of the solvent (S).

10. Device according to claim 9, characterized in that the interface between the diluent (D) and the solvent (S) is maintained stable by means of a system for measuring the respective levels (N1, N2, N3, N4) of the balancing recipients (R1, R2, R3, 4) acting on the flowrate regulation of the corresponding pump (P1, P2, P3, P4).
